(19) United States
(12) Patent Application Publication
(10) Pub. No.: US 2008/0208644 A1
(43) Pub. Date: Aug. 28, 2008

(54) Apparatus and Method for Measuring Service Performance

(75) Inventors: Peter M. Gray, Barrington, RI (US); Allan Tear, Providence, RI (US); Alex Abramov, Providence, RI (US); Vadim Slavin, Pawtucket, RI (US)

Correspondence Address: EDWARDS ANGELL PALMER & DODGE LLP, P.O. BOX 55874, BOSTON, MA, 02205, US

(73) Assignee: WhyData, Inc., Pawtucket, RI (US)

(21) Appl. No.: 11/666,216

(22) PCT Filed: Oct. 25, 2005
(86) PCT No.: PCT/US2005/038570

§ 371 Date: Apr. 9, 2008

Related U.S. Application Data
(60) Provisional application No. 60/621,713, filed on Oct. 25, 2004.
(60) Provisional application No. 60/684,814, filed on May 25, 2005.

(51) Int. Cl. G06Q 10/00; G06F 17/11

(52) U.S. Cl. 705/7

(57) ABSTRACT

A method for measuring satisfaction within a service environment including the steps of modeling contractual customer service relationships using a hierarchical composition model with discrete abstract elements, creating and distributing customer perception surveys having questions, wherein the questions are dynamically generated from a computer database based on events within the service environment and element weightings within a hierarchical composition model, collecting and analyzing the customer perception surveys, calculating aggregate measures of customer perception that have statistical reliability, correlating the measures of customer perception to create at least one statistical causality between customer perception and business performance and adjusting the element weights using calculated customer perception measures and statistical correlation measures to refine reliability of future analysis and calculation results.

### CROSS-REFERENCE TO RELATED APPLICATION

This application claims priority to U.S. Provisional Patent Application No. 60/621,713, filed Oct. 25, 2004 and U.S. Provisional Patent Application No. 60/684,814 filed May 25, 2005, each of which is incorporated herein by reference.

### BACKGROUND OF THE INVENTION

1. Field of the Invention

The subject disclosure relates to methods and systems for measuring service performance, and more particularly to improved methods and systems for using measures of service performance to enhance service.

2. Background of the Related Art

Companies have been using survey science and market research techniques for decades to gauge the satisfaction and loyalty that their products and services deliver to their customers. Although significant basic science and practice has been created, administration and analysis of satisfaction and loyalty measurement instruments is lacking sophistication. Current state-of-the-art methods fall into two broad categories of highly customized “snapshot” surveys and lightweight in-process surveys.

Highly Customized “Snapshot” Surveys are usually delivered by third-party consultants. Highly customized “snapshot” surveys are created using techniques and methodologies to measure customer satisfaction and loyalty for a specific company, their customer environment and service processes. Highly customized to the specific company's requirements, these surveys yield a high amount of analyzable data that is used to measure satisfaction levels, loyalty levels, drivers of satisfaction and loyalty, and to answer specific questions about the customer and market environment of the specific company. These “snapshot” surveys are created or customized “from scratch” and are often relatively expensive to create and administer. “Snapshot” surveys also have a low level of re-use, as their level of customization makes them inflexible as time passes, market or customer conditions change, or business priorities shift. Because companies invest so much in a “snapshot” survey, they are often long, and require an investment of time and attention by the survey respondent. These factors make it difficult to use the “snapshot” survey repeatedly for historical trending or continuous improvement purposes.

Lightweight “In-Process” Surveys are usually delivered by software vendors as stand-alone applications or integrated into comprehensive customer service software suites. These short surveys are delivered in an automated fashion in conjunction with customer service processes like help desk calls, technical support web applications, or field service follow-ups. By integrating with the customer service processes that end-customers are already interacting with, “in-process” surveys increase the timeliness and ease-of-completion of satisfaction and loyalty measurement. These surveys yield a consistent stream of data that can be associated with specific points in the service process, and support historical trending, problem resolution, and continuous improvement. The questions and structure of these “in-process” surveys are usually created without the benefit of state-of-the-art techniques or methodologies, and are often arbitrary creations guided only by the knowledge of the company that is using the “in process” survey tool. These surveys are often only usable as a “temperature check”, but lack detailed analysis, and reliability of the data for in-depth analytical determination of customer satisfaction, key drivers, and customer loyalty.

Additionally, both approaches to measurement of customer satisfaction and loyalty originated from the market and customer research communities. Thus, both approaches lack significant and meaningful linkage to the financial and operational data that is traditionally used by businesses for performance management of business processes and organizations. As a result, customer satisfaction and loyalty data has been “silo-ed” from financial and operational data, and is rarely analyzed in concert to determine the cause-and-effect relationships that can be determined by bringing the data together within an analytical framework.

### SUMMARY OF THE INVENTION

It is an object of the subject technology to determine the statistical relationship or correlation and causality between perception measures and financial, operational, and/or customer action measures within a contractual service environment.

It is another object of the subject technology to provide a set of software technologies to automate the collection, normalization and analysis to, in turn, provide the data for display, manipulation, and interpretation by end-users who are providers or customers in a contractual service environment.

In one embodiment, the subject technology is directed to a framework for measuring a perceived value of a service including a service modeling section for parsing the service into constituent modeled factors to create a service matrix having a plurality of nodes, each node being representative of a category of service performance, a data measurement section for inputting values for the modeled factors, a data analysis section for calculating a customer satisfaction figure of merit and a system feedback section for providing output based upon the customer satisfaction figure of merit.

In another embodiment, the subject technology is directed to a method for measuring satisfaction within a service environment including the steps of modeling contractual customer service relationships using a hierarchical composition model with discrete abstract elements, creating and distributing customer perception surveys having questions, wherein the questions are dynamically selected from a set of pre-defined questions in a computer database based on events within the service environment and element weightings within a hierarchical composition model, collecting and analyzing the customer perception surveys, calculating aggregate measures of customer perception that have statistical reliability, correlating the measures of customer perception to create at least one statistical causality between customer perception and business performance and adjusting the element weights using calculated customer perception measures and statistical correlation measures to refine reliability of future analysis and calculation results.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### DEFINITIONS

ANOVA Analysis: analysis of variance; a statistical method for making simultaneous comparisons between two or more means; a statistical method that yields values that can be tested to determine whether a significant relation exists between variables.

Business Performance Indicator: an operational or financial measure that is relevant to the Service Organization's service process and business model.

Customer Group: a classification of customers by common attributes, including demographics, business segmentation, and similar Importance measurements within the Service Measurement Framework.

Customer Performance Indicator: perception data at an individual or aggregate level for any factor of the Service Matrix. Customer perception data on an individual or aggregate level for any Service Matrix factor is referred to as a Customer Performance Indicator (CPI).

Dynamic Evaluation: question-based evaluative instruments generated by database driven software in response to a system or external event (external system flags, time periods, or database flags). Can be administered to any technology-enabled target (email, web, call center application, etc.).

Element Question: a question that is used to evaluate a respondent's perception of an element (Functional Element, Service Element, Service Category). When answered in conjunction with an evaluative mechanism (such as a 5 point Likert scale), a measurement of perception is created.

Functional Element: a sub-factor that further disaggregates and describes a service element within the Service Matrix. Functional Elements are detailed attributes or characteristics of service that can be measured through evaluative instruments, such as question-based evaluations.

Importance: relative priority that a customer places on service categories and service elements, as measured at a respondent level through an evaluative instrument.

Services: generally any valuable activity or benefit that one party can offer to another that is largely intangible.

Service Category: customer-visible or -experienced services, defined by using a process view from the end customer inwards; thus they are often different from the provider's view of services.

Service Element: attributes or characteristics of service that are experienced and perceived by customers during interaction with the provider through the delivery of services.

Service Matrix: The hierarchical relationship tree that is used within the Service Measurement Framework to specify the relationship between modeled and measured attributes of contractual service.

Service Organization: a company, business unit, or group which provides contractual services to customers.

Service Value: aggregate perception of the value of the service provider to an end customer, relative to competitive choices and likely customer actions. Represented by a set of measured factors as shown in FIG. 3: Service Value Submatrix.

Stakeholder Influence Map: a visual representation of relationships and their effect on contractual outcomes, containing relationship paths, influence strengths, likely actions, and outcome effects.

XML: eXtensible Markup Language, the universal format for structured documents and data on the Web.

Correlation Coefficient: a value between −1 and 1 inclusively, which quantitatively describes the linear correlation between two quantities. The coefficient closer to +1 means stronger correlation: two quantities are co-dependent and behave the same way. Coefficient around zero means that two quantities are most likely not related. Coefficient closer to −1 means strong relationship where one quantity behaves as an opposite of the other, the rise in one means fall in the other in the same period and vice versa. This value is a measure of how the quantities relate each other s change. If both quantities change in the same way (as one quantity rises above average so does the other one) then these quantities are highly positively correlated. If all quantities deviate differently (as one quantity rises above average the other one falls below the average) then these quantities are highly negatively correlated. The correlation coefficient around zero does not mean there is no relationship between the two quantities, only that there is no LINEAR relationship. For performance indicators this means that the relationship between the two quantities is not likely.

Certainty Value: the percentage (from 0% to 100%) which describes the certainty with which the Correlation Coefficient is calculated. A Certainty closer to 100% describes a high degree of certainty. A Certainty closer to 0% describes a low degree of certainty.

Time Period: defines the length of time for which the behavior of the quantity is considered, sampled, or measured. It is defined by the start date and the end date.

Lag: the time difference between the start dates of Time Period A and Time Period B.

Number of Sampling Points: defines how the quantity is resampled for the purpose of this algorithm. A performance indicator is stored in the system's database as a collection of values recorded at particular time instants. For a given Time Period the quantities need to be sampled at equidistant time instants in order to convert both to the same format suitable for calculation of the Correlation Coefficient. For the same Time Period different sampling rate may influence how accurately the quantity is presented for the algorithm thus influencing the quality of the algorithm results. This sampling rate is described b the Number of Sampling Points used to resample the quantity.

Under-Sampling: the event of resampling a quantity with too few of the Sampling Points thus losing information about the true recorded behavior of the quantity.

Correlationship: a term that defines CPI-BPI Relationship Correlation for a particular unique set of configuration parameters: CPI Time Period, BPI Time Period, Lag, and Sampling Rate.

### BRIEF DESCRIPTION OF THE DRAWINGS

So that those having ordinary skill in the art to which the disclosed system appertains will more readily understand how to make and use the same, reference may be had to the drawings wherein:

FIG. 1 is a block diagram of a Service Measurement Framework system implemented in accordance with the subject disclosure;

FIG. 2 is a flow diagram of a process performed by the Service Measurement Framework system of FIG. 1;

FIG. 3 is a diagram of a Service Matrix;

FIG. 4 is an exemplary service matrix in an Information Technology Shared Services environment;

FIG. 5 is the service matrix of FIG. 4 with exemplary weighted values;

FIG. 6 is an example of a correlation between parameters;

FIG. 7 is a process or procedural structure for correlation;

FIG. 8 is a looping structure related to the structure of FIG. 7; and

FIG. 9 is examplary BPI (B), CPI (C) data.

### DETAILED DESCRIPTION OF PREFERRED EMBODIMENTS

The present invention overcomes many of the prior art problems associated with measuring and evaluating service performance. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

In brief overview, the disclosed technology relates to measuring a perceived satisfaction and perceived value (e.g., perception measures) of customers and other stakeholders in a scientifically rigorous and repeatable manner over time. For example, the Service Measurement Framework (SMF), disclosed herein, is useful for the measurement of perception in contractual customer relationships where service is a dominant component of the scope of the contract, in terms of contract pricing, contractual performance clauses, profit margin and the like. The method of measurement includes modeling, collecting, normalizing, and analyzing the perception measures and the data that results from ongoing measurement.

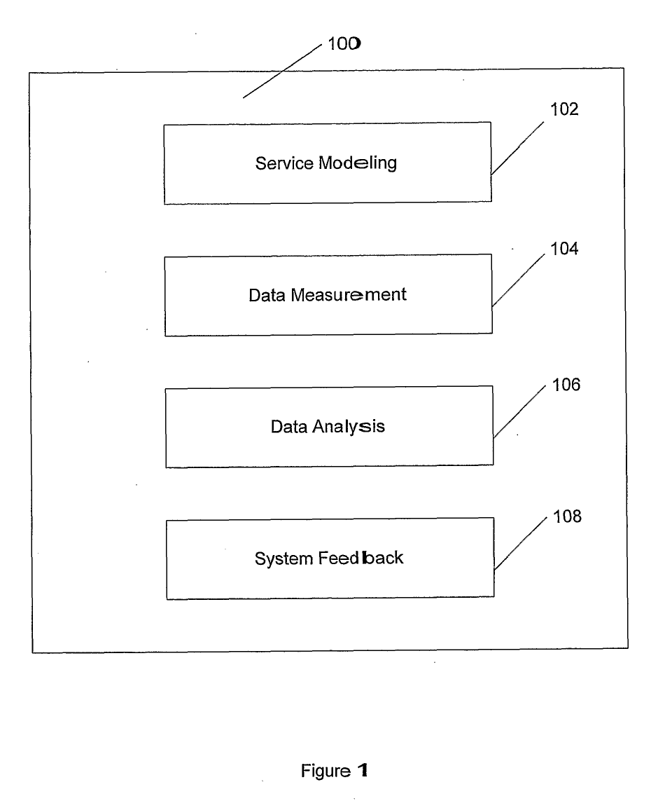

Referring now to the FIG. 1, there is shown a block diagram of a SMF 100 embodying and implementing the methodology of the present disclosure. The following discussion describes the structure of such a SMF 100 but further discussion of the applications program and data modules that embody the methodology of the present invention is described elsewhere herein.

The SMF 100 is a computer, preferably a server capable of hosting multiple Web sites and housing multiple databases necessary for the proper operation of the methodology in accordance with the subject invention. An acceptable server is any of a number of servers known to those skilled in the art that are intended to be operably connected to a network so as to operably link to a plurality of clients (not shown) via a distributed computer network (not shown). The server can also be a stand-alone system.

A server typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) is typically provided for purposes of booting and storing the operating system, and storing other applications or interacting with other systems that are to be executed on the server, like paging and swapping between the hard disk and the RAM.

Alternatively, the SMF 100 could be a computer such as a desktop computer, laptop computer, personal digital assistant, cellular telephone and the like. In another embodiment, such a computer allows a user to access a server to utilize the subject technology. It will be recognized by those of ordinary skill in the art that the hardware of the clients would be interchangeable.

Referring still to FIG. 1, the SMF 100 encompasses four major components: a Service Modeling component 102, a Data Measurement component 104, a Data Analysis component 106 and a System Feedback component 108. Flow charts are utilized to show the steps that the components of the SMF 100 may perform. The flow charts herein illustrate the structure or the logic of the subject technology as embodied in computer program software for execution on a computer, digital processor or microprocessor. Those skilled in the art will appreciate that the flow charts illustrate the structures of the computer program code elements, including logic circuits on an integrated circuit that function according to the subject technology. As such, the subject technology can be practiced by a machine component that renders the program code elements in a form that instructs a digital processing apparatus (e.g., computer) to perform a sequence of function steps corresponding to those shown in the flow diagrams.

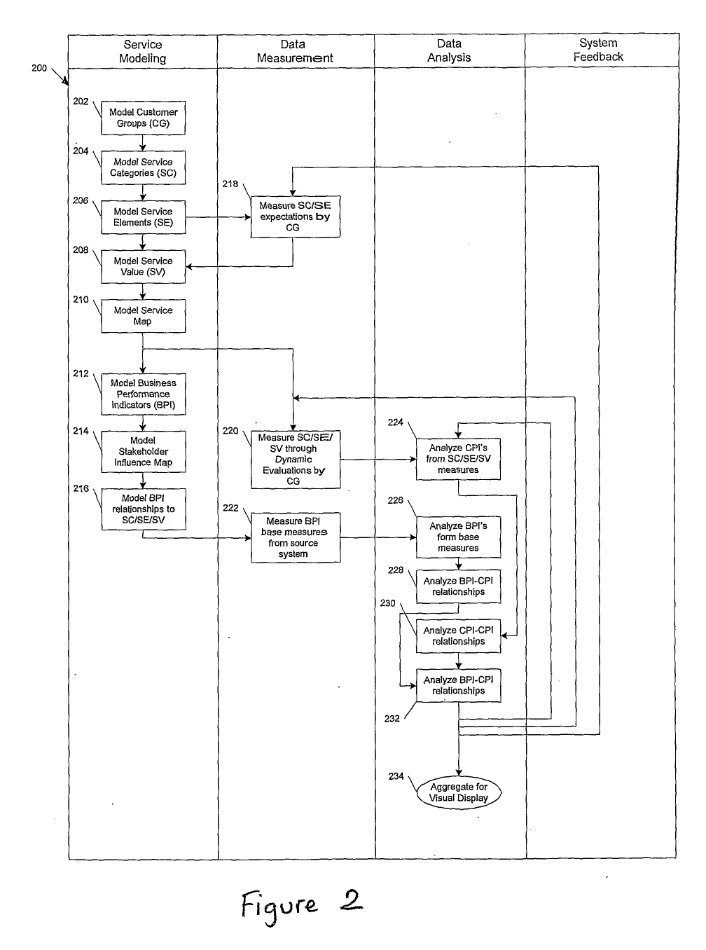

Referring now to FIG. 2, there is illustrated a flowchart 200 depicting a process of the function of the SMF 1 00. The flowchart 200 is organized such that the actions under the heading of “Service Modelling” are performed by the Service Modelling component 102, the actions under the heading of “Data Measurement” are performed by the Data Measurement component 104 and so on. The flowchart 200 is a process by which the SMF 100 models a business, collects data related to the business, normalizes the data, and analyzes perception measures on an ongoing basis to quantify satisfaction and compliance. As a result, performance and efficiency of the business can be enhanced.

Service, specifically, contractual service, is an abstract concept. In a real world environment, service is a collection of specific tasks, human interactions, and work products delivered over time. The delivery of these services by one party to another results in some real outcomes, and some perceived outcomes.

For example, small business tax preparation service is a contractual agreement between a small business entity (e.g., customer) and a professional tax firm (e.g., provider) to prepare taxes for filing with the U.S. government and state governments. The collection of intangibles as follows: the expertise of the provider, the availability of resources, the process of collecting and working with the financial data of the customer, advice, issue resolution, and so on. The service of the provider can be broken down into discrete services as follows: Expert tax advice; Process guidance and management; Financial data collection, manipulation, calculation, validation; Correct tax form determination and preparation; Error checking and data integrity; Audit avoidance advice; and Timely and accurate filing. The delivery of these services over time creates a set of perceptions in the customer. These perceptions, often referred to as “satisfaction” or “perceived value” are determined by the importance the customer places on the services being delivered, and the way in which the services are delivered versus the customer's expectations.

To continue with the example, a specific-small business customer engaging with the tax preparation provider will have a set of internal perceptions about what is important to them in this contractual service. The customer may place a higher importance on the tax expertise of the provider than on an empathetic approach to questions and issues. The customer may value the providers' repeated willingness to answer phone and email questions, or the accurate and complete return, with minimal interaction, the most. These preferences are rarely articulated, but the preferences determine the “lens” through which the customer experiences the service delivered by the provider.

At step 202, the Service Modelling component 102 begins by modeling customer groups (CGs) of a business that is utilizing the SMF 100. The SMF 100 defines customers and stakeholders as CGs according to service organization (SO) interviews and guided discovery. This step iterates with the results of the IMP measurement as CGs may segment uniquely by IMP.

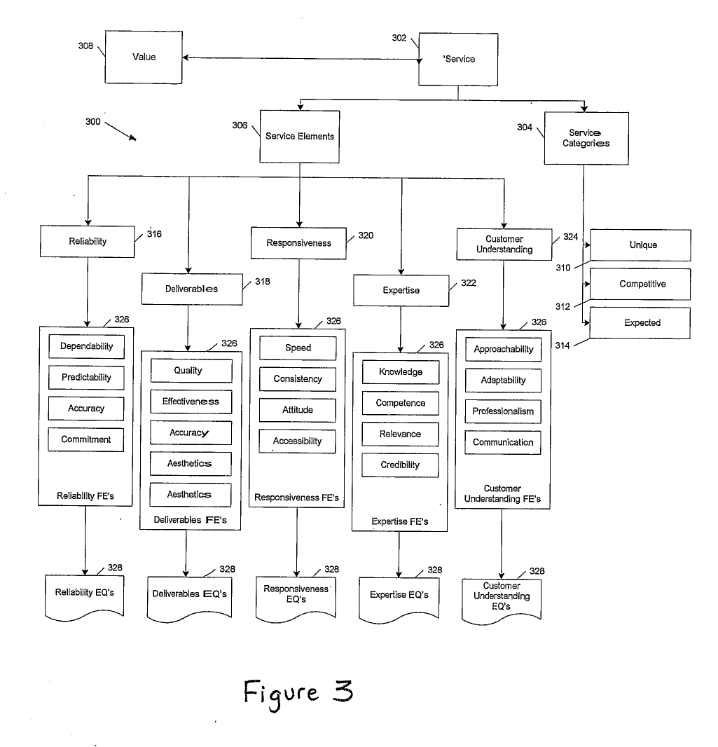

At step 204, the SMF 100 uses a hierarchical composition model or Service Matrix, generally referred to herein by the reference numeral 300, to break service 302 into its constituent modeled factors, as shown in FIG. 3.

Referring now to FIG. 3, the constituent modeled factors of the Service Matrix 300 include Service Categories 304, Service Elements 306, and Service Value 308. Service Categories 304 are customer visible or experienced services, defined by using a process view from the end customer inwards; thus service categories are often different from the provider's view of services. Service Categories 304 are defined and segmented from SO interviews, documents and guided discovery. Service Categories 304 are further defined by three groups: Unique 310, Competitive 312 and Expected 314.

Service Elements 306 are attributes or characteristics of service that are experienced and perceived by customers during interaction with the provider through the delivery of services. Service Elements 306 are further defined by five groups: Reliability 316, Deliverables 318, Responsiveness 320, Expertise 322 and Customer Understanding 324. Each group 316, 318, 320, 322, 324 further expands into Functional Elements (Fes) 326 and Element Questions (Eqs) 328.

Service Value 308 is an aggregate perception of the value of the service provider to an end customer, relative to competitive choices and likely customer actions. Service Value 308 may be represented by a set of measured factors. Customer perception data on an individual or aggregate level for any of these Service Matrix Factors is referred to as a Customer Performance Indicator (CPI).

Referring again to FIG. 2 as well as FIG. 3, at step 206, the SMF 100 models the Service Elements 306. The Service Elements 306 are defined using the Service Matrix 300 as a reference model. The Service Element Fes 326 and Eqs 328 of the Service Matrix 300 are validated and customized for the SO at the EQ level. The Data Measurement component 104 also participates in the flowchart 200 as part of step 206. The flowchart 200 passes from step 206 to step 218 where the Data Measurement component 104 directly measures Importance (IMP) through a question-based instrument by individual customers/stakeholders with a CG. IMP is measured through a forced choice method by which CGs must indicate the relative importance of SC/SE.

At step 208, Service Value 308 is defined using the Service Matrix 300 as the reference model. The definition of Service Value 308 is a function of the SO business context, and is chosen from a constrained set of Service Value variables as follows: Reference, Repurchase, Extension, Value to Business, and Value for Cost.

At step 210, the SMF 100 creates a model service map by using process mapping to further model the Service Categories 304. Process mapping is a visual representation of process flow that spans inputs, major tasks, activities, outputs, SO staff responsibilities, customer and stakeholder interfaces, major work products, existing financial measures and operational measures.

Intermediate steps 210 and 212, the flowchart 200 again passes control to the Data Measurement component 104 at step 220. The Data Measurement component 104 measures satisfaction with SC, SE and/or SV through Dynamic Evaluations (DE). DEs are question-based instruments generated by database driven software in response to a system or external event. Events can include external system flags, time periods and/or database flags. EQs are generated for the designated CGs using their IMP measures and the Service Matrix. DEs are administered to any technology enabled target such as email, Web applications, call center applications and the like. Measures are calculated from returned DE responses by respondents. SE/SC/SV measures are aggregated by CG for database defined periods.

As the flowchart 200 passes through step 220, control also passes to the Data Analysis component 106 at step 224. The Data Analysis component 106 analyzes the CPIs from the calculated SC/SE/SV measures. CPIs may be analyzed by statistical comparison to database defined threshold values or over time periods for historical trending. For example, obtained CPI values can be compared to statistical composite values such as mean, median, 95% range, a specified percentile range based on thresholded range of values and the like. In a preferred embodiment, CPI values are analyzed using statistical formulas to compare newly obtained data to previous data. This can be used for historical trending, evaluating the significance of the obtained data and confidence intervals. Confidence Intervals are the range of data values where the true value to be estimated lies with high probability. Then, control passes to step 230 and the Data Analysis component 106 analyzes the statistical relationships between CPIs using correlation analysis over database defined time periods. ANOVA analysis techniques are used to measure CPI correlations that are above database defined thresholds of significance (i.e., statistical significance). Pairwise and multivariate correlation analysis are used to isolate CPI statistical relationships that are causal and not merely covariant (i.e., driver relationships).

Still Referring to FIGS. 2 and 3, at step 212, Business Performance Indicators (BPIs) are defined and segmented from existing measures, SO interviews, contracts, service level agreements and guided discovery. BPIs are refined from a list of financial and operational measures to a set that determines contract and organizational performance.

At step 214, CGs are further modeled into a stakeholder influence map. The stakeholder influence map is a visual representation of relationships and their effect on contractual outcomes. CGs are assigned relationship paths, influence strengths, likely actions and outcome effects based on historical data and SO discovery.

At step 216, BPI relationships to Service Categories 304, Service Elements 306 and Service Value 308 are modeled from SO guided discovery and any other available relevant data as would be appreciated by those of ordinary skill in the pertinent art. All factors are mapped using a visual relationship map, and assigned relationship paths, influence strengths, and leading/lagging/coincident designations.

As the flowchart 200 passes from step 216 to step 222, the Data Measurement component 104 also receives BPI base measures from external source systems for storage in database using predefined interfaces. For example, in an Internet hosted application, the interfaces would be in XML. As a result, BPIs can be calculated from BPI base measures using database defined rules.

At step 226, the Data Analysis component 106 analyzes the BPIs from BPI base measures. Statistical relationships between BPIs are measured using statistical correlation analysis over database defined time periods. ANOVA analysis techniques are used to measure BPI correlations that are above database defined thresholds of significance (i.e., statistical significance). Again, pairwise and multivariate correlation analysis are used to isolate BPI statistical relationships that are causal and not merely covariant (i.e., driver relationships).

At step 228, BPI to BPI relationships are analyzed. BPIs are analyzed from the BPI Base Measures or any calculated variant of the BPI Base Measures. BPI may be analyzed by statistical comparison to database defined threshold values or over time periods for historical trending. As noted below, a correlation between parameters is generally applicable. For example, once converted to generic quantities for comparison, the inputs can be of any nature (e.g., BPI-BPI, CPI-CPI and BPI-CPI), provided that the input quantities are sampled in the relevant time periods.

At step 232, the Data Analysis component 106 receives data from various other steps to analyze BPI to CPI relationships. Statistical relationships between BPIs and CPIs are measured using statistical correlation analysis over database defined relevant time periods. As a result, the input quantities are converted or normalized for comparison, evaluation and use by sampling over relevant time periods. Again, ANOVA analysis techniques are used to measure BPI and CPI correlations that are of statisitical significance, and pairwise and multivariate correlation analysis are used to isolate BPI and CPI statistical relationships that are driver relationships. Typically, every CPi-BPI pair has some statistical relationship. Preferably, the SMF 100 samples quantities and runs the process to assign a score between −1 and 1. A score of approximately −1 and 1 signifies a strong relationship or dependency. A score near zero signifies a weak relationship or little dependence, i.e., random behavior relative to each other. A weak relationship might be important for analysis since this could mean that over the sampled time period, the two quantities had no effect on one another. On the other hand a strong relatinoship may be a direct, trivial dependency of no interest to the analysis. In any event, a consultant would interpret the results as would be appreciated by those of ordinary skill in the pertinent art. Preferably, the consultant chooses the bounds (i.e., thresholds) of the ‘score’ (e.g., the correlatinship coeeficient) for isolating the pairs.

In view of the above, several techniques for measurement and analysis have been developed to be utilized in the SMF 100. Regarding basic CPI measurement and analysis, when the SMF 100 is used to measure customer perception of service, the measured Service Matrix data that is created from the Dynamic Evaluation responses are called Customer Performance Indicators (CPIs). There are three types of CPIs: Measured CPIs, Modeled CPIs and Importance CPIs. Measured CPIs are the CPIs that have Evaluation Questions (EQ) directly associated therewith. Preferably, EQ's have exclusive hierarchical relationships within the Service Matrix to a single CPI; thus no one question can be associated with more than one CPI. A CPI may have multiple EQ's associated therewith.

In order to calculate a Measured CPI, an average of EQ score is calculated for a given Respondent:

CPIₘₑₐₙₛ=Avg(Qscores)

A Modeled CPI is a CPI that is calculated from the values of other CPIs (either Measured or Modeled):

CPI_{mod}=F({CPI₁,CPI₂, . . . ,CPIₙ})

where F is some function, such as the weighted average operation:

CPI_{mod}=IMP₁*CPI₁+IMP₂*CPI₂+ . . . +IMPₙ*CPIₙ

where IMPₙ are Importance CPIs and “*” stands for multiplication. Importance CPIs, like Measured CPIs, have EQs directly associated with them.

Dynamic Evaluation Generation Algorithm

In one embodiment, a Dynamic Evaluation Generation Algorithm (DEG) is used to generate Dynamic Evaluations (DE) customized for each Respondent o f FIG. 2. The DEs are distributed to respondents in order to measure an SC/SE/SV perception value. As noted above, a measured SC/SE/SV perception is called a Customer Performance Indicator (CPI). A DE is generated by an event, such as a service call being closed, a project phase being completed, a visit to a branch office, and the like. Events are normally generated by external software systems which send notifications, or internal software notifications such as timers or action flags. A typical DE request contains such information as who is to be surveyed, which CPIs are to be measured and how many questions per each CPI need to be generated. A CPI may be any of Service Category (SC), Service Element (SE) or Service Value (SV).

Question generation proceeds differently for each CPI type. For Measured and Importance CPIs, the questions are randomly picked from a pool of questions associated with a CPI. Modeled CPIs question generation is done differently. Because Modeled CPIs do not have questions directly associated therewith, the questions must be picked by examining the constituent CPIs from which a Modeled CPI is calculated. A Modeled CPI is calculated according to the following:

CPI_{mod}=w₁*CPI₁+w₂*CPI₂+ . . . +wₙ*CPIₙ

First, the algorithm gathers all the weights wᵢ. The weights are selected by an expert or determined through empirical analysis and the like. Next, a range of all possible values is determined by summing up the weights wᵢ, and a random number is generated that falls within that range. This results in a weight wⱼ into which range the random number happens to fall, which, in its turn, results in picking a CPIⱼ associated with weight wⱼ.

If CPIⱼ is a Measured CPI, the DEG proceeds to pick a random question from a pool of questions associated with that CPI. If CPIⱼ is a Modeled CPI, then the process of selecting one of the constituent CPIs from which the Modeled CPI is calculated continues recursively until the algorithm reaches a Measured CPI. This procedure is executed for each Respondent x times, where x is the number of questions specified in the Dynamic Evaluation Generation request.

CPI Value Aggregation Algorithm

Given the Evaluation Question (EQ) scores for each respondent, the CPI value aggregation algorithm calculates CPI values for each Respondent surveyed and various groups of Respondents (i.e., CGs). The CPI value aggregation algorithm is used at step 230 of FIG. 2. The CPI value aggregation algorithm executes in two steps. In the first step, all the CPI values are calculated for each Respondent. In the second step, CPI values for groups of respondents (CGs) are calculated.

To calculate the CPI Values for a single Respondent, Measured and Importance CPIs are measured by averaging the question scores obtained from the filled out DEs during a given time period. After calculating the value for a Measured CPI, the CPI value aggregation algorithm analyzes which Modeled CPIs depend on the Measured CPI just calculated. Modeled CPIs are evaluated according to the following:

CPI_{mod}=w₁*CPI₁+w₁*CPI₂+ . . . +wₙ*CPIₙ

For each of those Modeled CPIs, the CPI value aggregation algorithm attempts to calculate a new value. If the value data is missing for one of the CPIs involved in the formula, the CPI value aggregation algorithm temporarily abandons the calculation and returns when one of the missing CPIs in the formula is available. When a Modeled CPI is calculated, the CPI value aggregation algorithm analyzes which other Modeled CPIs depend on the value of the current Modeled CPI. The CPI value aggregation algorithm continues to execute recursively until it is either no longer possible to calculate a Modeled CPI because one of the dependant CPIs is missing a value, or if a final Modeled CPI value has been calculated and there is no CPI that depends therefrom.

In a preferred embodiment, the SMF 100 calculates CPI Values for groups of respondents. After the CPI values for individual respondents have been calculated, the algorithm proceeds to calculate the CPI values for relevant Customer Groups (CGs) in the following way:

CPI(cgᵢ)=Avg({CPI(r₁),CPI(r₂), . . . ,CPI(rₙ}),

where rᵢ is a respondent, CPI(rᵢ) is a CPI value for rᵢ and CPI(cgᵢ) is a CPI value for Customer Group cgᵢ. In order to calculate a CPI value for a respondent group, the CPI values of its members are averaged. The overall CPI value is computed by performing weighted average operation on the CPI values of respondent groups defined within the SMF 100 according to the following:

CPI(overall)=w₁*CPI(cg₁)+w₁*CPI(cg₂)+ . . . +wₙ*CPI(cgₙ),

where wᵢ is a weight associated with CPI(cgᵢ), and CPI(cgᵢ) is a CPI value for respondent group cgᵢ.

Referring now to FIG. 4, the SMF 100 can be used in the Information Technology Shared Services (ITSS) environment and a typical grouping is shown and referred to generally by the reference numeral 400. The logical relationships within an organization form a tree structure that can be used to calculate Customer Satisfaction (SAT), represented as node 402 in FIG. 4. In a typical ITSS organization, the service inventory can be grouped into the following common service categories: Desktop Computing Support (DESK), Business Computing Support (BUS), Customer Application Support (APP), and Network Infrastructure Support (NETW). Each service category is represented as a node 404 in FIG. 4. Each service category is decomposed into 5 standard service elements 406: Reliability (RS), Responsiveness (RS), Customer Understanding (CU), Deliverables (DL) and Expertise (EX). Each node 402, 404, 406 in FIG. 4 represents a CPI. The following CPIs are Modeled CPIs: SAT, DESK, NETW, APP, BUS. RL, RS, CU, DL and EX are Measured CPIs and have Evaluation Questions associated with them.

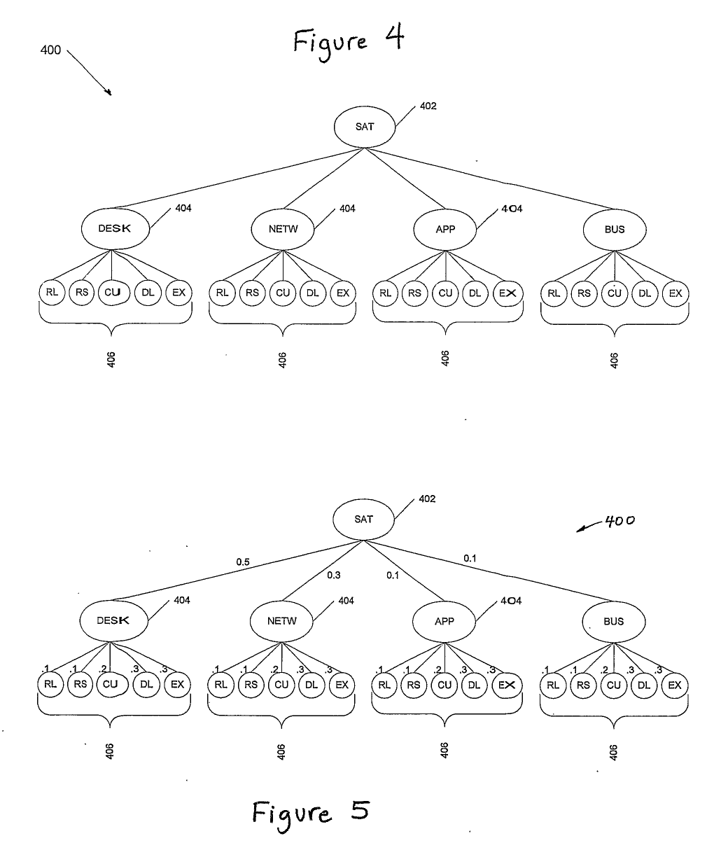

Referring now to FIG. 5, the service matrix of FIG. 4 is modified to represent numerical weights for a Respondent R. The numerical weights are the relative Importance weights that were collected from R prior to the event. The DEG Algorithm is supplied with the CPI (SAT in this case) for which a question needs to be generated for the Respondent R. Since SAT is a Modeled CPI and does not have questions directly associated therewith, the DEG algorithm refers to one of the “child” CPIs (e.g., DESK, NETW, APP and BUS). In order to pick a “child” CPI, the DEG algorithm generates a random number in a range from 0 to 1. If the generated number falls in a range between 0 and 0.5, then the DESK CPI is picked, if between 0.5 and 0.8, the NETW CPI is picked, if between 0.8 and 0.9, the APP CPI is picked and if between 0.9 and 1.0, the BUS CPI is picked. The CPI with higher weight is more likely to get picked since the weight spans a larger range of random number space.

For example, assume that the DEG algorithm has picked the DESK CPI. Since that CPI is also a Modeled CPI and does not have questions directly associated therewith, the DEG algorithm must recursively continue picking DESK CPI's “child” CPI (e.g., RL, RS, CU, DL or EX). Using the above described procedure, this example continues as if the DEG algorithm picked EX. EX is a measured CPI and has questions associated therewith. Next, the DEG algorithm picks a random question from a pool of questions directly associated with EX. The question generation executes x times, where x is the total number of questions that Dynamic Evaluation needs to contain.

### Question Score Aggregation

After Dynamic Evaluation (DE) is completed, the question scores are aggregated. For example, the DE for Respondent R contained the following 5 question scores:

1. EX question in DESK Service Category—score: 5

2. DL question in NETW Service Category—score: 3

3. RS question in DESK Service Category—score: 4

4. CU question in APP Service Category—score: 1

5. RS question in NETW Service Category—score: 1

Next, the DEG algorithm proceeds with calculating the values for Service Category CPIs (DESK, NETW, APP and BUS). The score for APP CPI is 1, since there is only data for EX CPI. Since BUS CPI does not have any question scores for its “child” CPIs, its value cannot be calculated. DESK CPI's value is calculated by performing weighted average operation on EX and DL scores as follows:

DESK CPI value=0.75*EX+0.25*DL=0.75*5+0.25*4=4.75

Note that the exemplary weights 0.75 for EX and 0.25 for DL are calculated by normalizing the weights 0.3 for EX and 0.1 for DL (e.g., EX weight=0.3/(0.3+0.1)). The NETW CPI value is calculated to be 0.75*3+0.25*1=2.5. Next, the DEG algorithm calculates the value for SAT CPI by performing weighted average operation on DESK, NETW and APP CPIs. After the normalization, the importance weights come out to be 0.56, 0.33 and 0.11 for DESK, NETW and APP, respectively.

SAT CPI value=0.56*DESK+0.33* NETW+0.11*APP=0.56*4.75+0.33*2.5+0.11*1=3.6

The SAT CPI value, when observed independently, is used to derive a customer's overall satisfaction with the service performance of a provider. In addition, when broken down to the individual components, the SAT CPI value is used to identify shortcomings in service areas based on customers perception of various services. When the individual measures are compared to the importance measures, the ratings are used to identify the prioritized list of delivered service and the satisfaction level with each. Changes to the SAT CPI value help a service provider determine action to insure a high level of satisfaction and loyalty are maintained. Additionally, when correlated to BPI values, the SAT CPI value ensures that alignment to service investment is maintained.

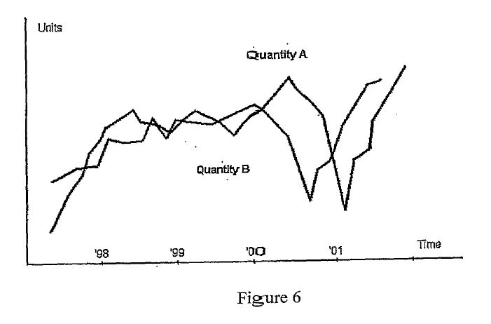

Referring now to FIGS. 6-9, a method for correlating CPI to BPI is illustrated. In brief overview, continuous measurement of the Customer Performance Indicators (CPIs) and Business Performance Indicators (BPIs) results in accumulation of vast amounts of historically traceable data suitable for mining. This enables discovery of correlation between CPIs and BPIs allowing tracking changes in forward looking indicators (CPIs) and backwards looking ones (BPIs). This correlation can describe how one quantity behaves in relation to the other or if there is any relationship at all between these two quantities. This relationship can help to better estimate the affect that the modifications of business parameters have on the perceived value of the relationship between the parties involved. Therefore, the purpose of this algorithm is to discover and/or check the strength of the relationship between CPI and BPI pairs.

Referring in particular to FIG. 6, auantities A and B are strongly correlated during '00, '01 Time Period with a time lag of about a half of a year (Quantity A is lagging behind Quantity B). There seems to be little Correlationship for the Time Period of '98, '99 Functionality. The CDA algorithm procedure can be divided into 5 steps as follows.

### Step 1. Input Specification

This step includes the scheduling of the running of the algorithm and specification of input parameters. Depending on the context in which the Correlation Discovery engine is to be run, the input parameters include a combination of the following:

i. Group(s) of CPIs and BPIs.

ii. Time Period for the CPI.

iii. Number of Sampling Points.

iv. Number of Lag Iterations to examine.

The types of the input parameters to be used are governed by the UI design. For example, the Number of Sampling Points can be either manually specified or calculated based on more complex statistical analysis of each of the quantities.

### Step 2. Iteration

The purpose of this step is to isolate a particular CPI-BPI pair and define exact Time Periods for which to consider these quantities and subsequently calculate the Correlation Coefficient. (For more detailed explanation see below)

Step 3. Resampling of the quantities and calculating the Certainty Value.

For an isolated CPI-BPI pair, both quantities are resampled to make them be of the same format and include the same Number of Sampling Points:

C={c₁, c₂, . . . , cₙ}-CPI quantity

B={b₁, b₂, . . . , bₙ}-BPI quantity

Where,

C is the CPI quantity defined by a set of n values: c₁, c₂, . . . , cₙ

B is the BPI quantity defined by a set of n values: b₁, b₂, . . . , bₙ Based on how much information is contained for each of the quantity in the pair, a Certainty Value is calculated. (For more detailed explanation see below)

### Step 4. Calculating the Correlation Coefficient for the Correlationship

The Correlation Coefficient is calculated in this step. (For more detailed explanation see below).

### Step 5. Reporting

Different user interface (UI) design choices guide the reporting of the results. Specific UI context will have a different way of presenting the results. The three main contexts are as follows:

i. Reporting a series of Correlationships together with the Correlation Coefficient for a particular group of CPI-BPI pairs.

ii. Reporting the strongest or weakest Correlationships for each selected CPI-BPI pair.

iii. Reporting the lag for the strongest Correlationships for each selected CPI-BPI pair.

Specific reporting contexts are left up to the UI designer while all of the required data for such reporting is stored in the database as a result of the algorithm.

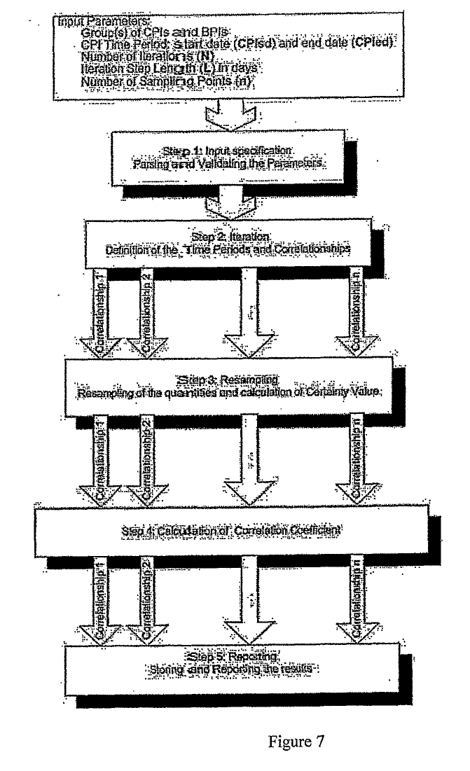

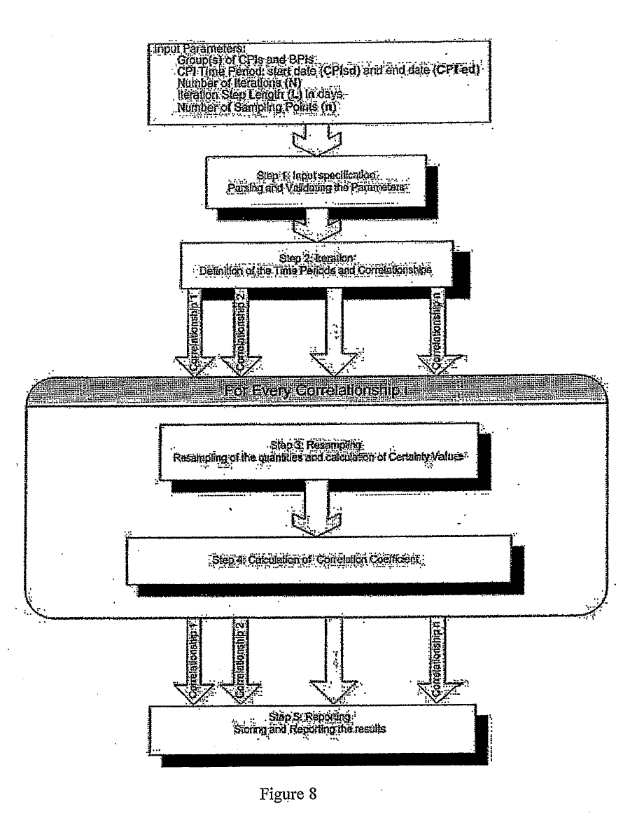

Referring now to FIGS. 7 and 8, a procedural structure is shown. The procedural approach completes each step and delegates the results to the next step. Each step is visited only once and all Correlationships are operated on in bulk at each step. The looping approach prepares the Correlationships at Step 2 and then for each Correlationship visits steps 3 and 4 in sequence.

### Step 1: Input Specification—Detailed Description

The input specification happens in the admin section of the user interface.
The user can chose to run the engine for
a group of contracts
a specific contract
a specific CPI-BPI pair
The user has the ability to schedule the engine to be run immediately, once in the future, or as a recurring event. The user should have the ability to specify a collection of the above entities (groups of contracts, specific contract, BPI-CPI pairs) and define configuration settings for them. A particular setting should be saved in the database and scheduled for running as one process. The BPIs and CPIs should be chosen from a list of BPIs and CPIs so that the discovery can be run permuting all possible thus resulting pairs. Selection of a particular pair results from specifying only one BPI and only one CPI in corresponding group.

### Step 2: Iteration—Detailed Description

Input Parameters:
Group(s) of CPIs and BPIs
CPI Time Period: start date (CPIsd) and end date (CPIed)
Number of Iterations (N)
Iteration Step Length (L) in days
Number of Sampling Points (n)
Given a group of CPIs and BPIs the algorithm iterates through all possible CPI-BPI pairs.
For each CPI-BPI pair a Correlationship is defined as follows:
Correlationship:
CPI quantity
BPI quantity
CPI Time Period: start date (CPIsd) and end date (CPIed)
BPI Time Period: start date (BPIsd) and end date (BPIed)
Number of Sampling Points
Therefore, for one CPI-BPI pair there are 2N+1 possible Correlationships because there are 2N+1 possible BPI Time Periods as specified by the input parameters.
For Correlationship i we calculate BPI Time Period as follows:

i=−N. . . . ,−1, 0, 1, . . . , N
Where “i” takes on the integer values from −N to N and serves to identify each one of the (2N+1) Correlationships.

BPIsdᵢ=CPIsd+i·L

BPIedᵢ=BPIsdᵢ+(CPIed−CPIsd)

Lagᵢ=CPIsd−BPIsdᵢ=CPIed−BPIedᵢ
Where
BPIsdᵢ—start date of the BPI value of Correlationship i
BPIedᵢ—end date of the BPI value of Correlationship i
L—iteration step length
CPIsd—start date of the CPI value of each of the Correlationships
CPIed—end date of the CPI value of each of the Correlationships
The values of CPIed and CPIsd do not have the subscript because they are equal across all Correlationships by definition.
Lagᵢ—lag for Correlationship i
For each CPI-BPI pair two Correlationships are formed because two CPI values are recorded at each time—one for the Service Receiver, one for Service Provider.
   Step 3: Resampling of the quantities and calculating the Certainty Value—Detailed Description
For a given BPI-CPI Correlationship the two quantities (BPI and CPI) are sampled for the specified Time Periods. As seen in Step 2, the Time Periods must be equal in length but do not have to coincide.
The sampling of the quantities is done at equidistant instants of time so that both quantities include the same Number of Sampling Points, n:
C={c₁ c₂ . . . cₙ}—CPI quantity
B={b₁ b₂ . . . bₙ}—BPI quantity Where,
C is the CPI quantity defined by a set of n values: c₁, c₂, cₙ,
B is the BPI quantity defined by a set of n values: b₁, b₂, . . . , bₙ
Given the Time Periods for the given Correlationship,
CPI Timer Period: CPIsd, CPIed
BPI Timer Period: BPIsd, BPIed
We sample both quantities at equal time step lengths:

$$j = 1 , 2 , … , n$$

$${TimeC}_{j} = CPIsd + ( j - 1 ) \cdot \frac{CPIed - CPIsd}{n - 1}$$

$${TimeB}_{j} = BPIsd + ( j - 1 ) \cdot \frac{CPIed - CPIsd}{n - 1}$$

Where
n is the number of sampling points.
j takes on each of the values between 1 and n
TimeBⱼ, TimeCⱼ are the instants of time at which to sample BPI and CPI quantity respectively.
CPIed—start date of the CPI value of the Correlationship
CPIed—end date of the CPI value of the Correlationship

The Number of Sampling Points can be either specified manually or computed according to the following logic in order to avoid Under-Sampling. Because values for Performance Indicators are recorded once in the age period, for example, by sending out the questionnaires once in a period of time, the age period for each quantity contains one value. When we resample this data again for the purposes of running the discovery algorithm, we need to make sure that we do not Under-Sample the data and so the sampling should not happen less often then the age period of the least frequently sampled quantity:

$$n = \frac{CPIed - CPIsd}{min ( {st}_{BPI} , {st}_{CPI} )} = \frac{BPIed - BPIsd}{min ( {st}_{BPI} , {st}_{CPI} )}$$

Where
n is the number of sampling points.
CPIsd—start date of the CPI value of the Correlationship
CPIed—end date of the CPI value of the Correlationship
st_{BPI}, st_{CPI}—age periods of BPI and CPI respectively
min( . . . , . . . )—the ‘minimum’ operation which outputs the minimum value out of the values listed inside the parentheses.
In other words, we use the frequency of sampling of the most frequently sampled quantity to avoid under-sampling.

cⱼ=Ave([TimeCⱼ−st_{CPI}, TimeCⱼ+st_{CPI}])

bⱼ=Ave([TimeBᵢ−st_{BPI}, TimeBᵢ+st_{BPI})
Where
cⱼ is the j^{th} value of the CPI quantity, j 1, 2, . . . , n
bⱼ is the j^{th} value of the BPI quantity, j 1, 2, . . . , n
TimeBⱼ, TimeCⱼ are the instants of time at which to sample BPI and CPI quantity respectively st_{BPI}, st_{CPI}−age periods of BPI and CPI respectively
Ave([TimeCⱼ−st_{CPI}, TimeCⱼ+st_{CPI}]) is the average of values for the CPI quantity for the time period from TimeCⱼ−st_{CPI} to Time Cⱼ+st_{CPI}.

### Special Case of Undefined Values.

In special cases when no values are recorded for the specified time period for either quantity, the relative behavior of the quantities is not defined at this time step. For example, if either Cⱼ or bⱼ is undefined, the relative behavior for time step j is undefined. There are two methods considered to remedy such situation.

### Method 1.

If either of the quantities is not defined for a time step then both quantities will have this step's value as the respective mean of defined step values of the respective quantity. This way the correlation coefficient will not be affected by the undefined time step. The uncertainty in such cases contributes to the measure of Certainty, which is computed separately for this correlation coefficient.

### Method 2.

The missing value for the time step is computed to be the linear (or other) interpolation of the two neighboring values. Therefore, the missing value is defined and this time step can now contribute to the overall Correlation Coefficient value. It has to be noted that this time step will contribute to lowering of the Certainty factor. The formula for computing the interpolated value is as follows:

$${c}_{j} = \overleftarrow{{c}_{j - 1}} + \frac{{TimeC}_{j} - Time \overleftarrow{{C}_{j - 1}}}{Time \vec{{C}_{j + 1}} - Time \overleftarrow{{C}_{j - 1}}} \cdot ( \vec{{c}_{j + 1}} - \overleftarrow{{c}_{j - 1}} )$$

Where

Cⱼ is the j^{th} value of the CPI quantity, j=1, 2, . . . , n

Cⱼ₊₁—first value for quantity C in the database after TimeCⱼ

Cⱼ₋₁ —last value for quantity C in the database before TimeCⱼ

TimeCⱼ—the instant of time for which the value Cⱼ is calculated.

Time Cⱼ₊₁—time stamp of the first value for quantity C in the database after TimeCⱼ

TimeCⱼ₋₁ time stamp of the last value for quantity C in the database before TimeCⱼ

Similarly for the BPI quantity

$${b}_{j} = \overleftarrow{{b}_{j - 1}} + \frac{Time {B}_{j} - Time \overleftarrow{{B}_{j - 1}}}{Time \vec{{B}_{j + 1}} - Time \overleftarrow{{B}_{j - 1}}} \cdot ( \vec{{b}_{j + 1}} - \overleftarrow{{b}_{j - 1}} )$$

Where

bⱼ is the j^{th} value of the BPI quantity, j=1, 2, . . . , n

bⱼ₊₁—first value for quantity B in the database after TimeBⱼ

bⱼ₋₁—last value for quantity B in the database before TimeBⱼ

TimeBⱼ—the instant of time for which the value bⱼ is calculated.

Time Bⱼ₊₁—time stamp of the first value for quantity B in the database after TimeBⱼ

Time Bⱼ₋₁—time stamp of the last value for quantity B in the database before TimeBⱼ

### Calculation of the Certainty Value

Only if both quantities return a value for a particular time step we consider this step to be successfully contributing to the Correlation Coefficient. We count the number of steps successfully contributing to the Correlation Coefficient, k.

Then,

$$Certainty = \frac{k}{n} \cdot 100 \%$$

Where

n—number of steps in the time period

### Step 4: Calculation of the Correlation Coefficient

Given resampled quantities C and B with n Sampling Points

C={c₁ c₂ . . . cₙ}

B={b₁ b₂ . . . bₙ}

Where,

C is the CPI quantity defined by a set of n values: c₁, c₂, . . . , cₙ

B is the BPI quantity defined by a set of n values: b₁, b₂, . . . , bₙ.

The Correlation Coefficient ρ_{C,B} is calculated as follows:

$$\begin{matrix} \\ {ρ}_{C , B} = \frac{Cov ( C , B )}{{δ}_{C} {δ}_{B}} \\ \end{matrix}$$

Where

$$Cov ( C , B ) = \frac{1}{n} {\sum }_{j = 1}^{n} ( {b}_{j} - {μ}_{B} ) ( {c}_{j} - {μ}_{C} )$$

$${μ}_{B} = \frac{1}{n} {\sum }_{j = 1}^{n} {b}_{j}$$

$${μ}_{C} = \frac{1}{n} {\sum }_{j = 1}^{n} {c}_{j}$$

$${δ}_{B} = \sqrt{\frac{1}{n} {\sum }_{j = 1}^{n} {( {μ}_{B} - {b}_{j} )}^{2}}$$

$${δ}_{C} = \sqrt{\frac{1}{n} {\sum }_{j = 1}^{n} {( {μ}_{C} - {c}_{j} )}^{2}}$$

Simplifying the formula we get

$$\begin{matrix} \\ {ρ}_{C , B} = \frac{{\sum }_{j = 1}^{n} ( {μ}_{B} - {b}_{j} ) ( {μ}_{C} - {c}_{j} )}{\sqrt{{\sum }_{j = 1}^{n} {( {μ}_{B} - {b}_{j} )}^{2}} \sqrt{{\sum }_{j = 1}^{n} {( {μ}_{C} - {c}_{j} )}^{2}}} \\ \end{matrix}$$

Where

bⱼ is the j^{th} value of the BPI quantity, j=1, 2, . . . , n

cⱼ is the j^{th} value of the CPI quantity, j=1, 2, . . . n

μB—the average of the BPI values for the given time period

μC—the average of the CPI values for the given time period

δB—the standard deviation of the BPI values for the given time period

δC—the standard deviation of the CPI values for the given time period

### Step 5: Storing and Reporting Results—Detailed Description

For every pair of quantities (BPI <−>CPI_SvcProvider for example) we compute the correlation coefficient in the interval [−1, 1]. We also compute the certainty percentage in the interval [0%, 100%]. We also record the timestamp of when the process is run. In Summary, the list of the output parameters is as follows: Correlation coefficient; Certainty percentage; Timestamp date. An Additional table will be created in the database with columns as follows: Contract ID; BPI ID; CPI ID; Org ID; CPI FROM date; CPI TO date; Steps value; Correlation coefficient for Service Receiver; Correlation coefficient for Service Provider; Certainty percentage for Service Receiver; Certainty percentage for Service Provider; Timestamp date. The reporting of this data can be as follows in Table 1.

TABLE 1

| | Service | Service | |
|---|---|---|---|
| BPI | Provider | Receiver | CPI |
| <bpi name> | <Value> | <Value> | <cpi name> |

Where the color of the cell displaying the Correlationship value will correspond to the strength of the relationship. The strength o characterized by the proximity of the absolute value of the Correlationship coefficient to 1 as described in the definition of the Correlation coefficient. For example, the database contains the following data for BPI (quantity B) and CPI (quantity C) with age periods of 14 days. See Table 2.

TABLE 2

| | Date | | | | | | | | | | | | | |
|---|---|---|---|---|---|---|---|---|---|---|---|---|---|---|
| | 1-Jan | 15-Jan | 1-Feb | 15-Feb | 1-Mar | 15-Mar | 1-Apr | 15-Apr | 1-May | 15-May | 1-Jun | 15-Jun | 1-Jul | 15-Jul |
| B | 25 | 30 | 45 | 61 | | 34 | 33 | 32 | 28 | 24 | 30 | 40 | 51 | 54 |
| C | 50 | 66 | 59 | 39 | 38 | 37 | 33 | 29 | 35 | 45 | | 59 | 62 | 48 |

| | Date | | | | | | | | | |
|---|---|---|---|---|---|---|---|---|---|---|
| | 1-Aug | 15-Aug | 1-Sep | 15-Sep | 1-Oct | 15-Oct | 1-Nov | 15-Nov | 1-Dec | 15-Dec |
| B | 57 | 43 | 39 | 38 | 36 | 31 | 29 | 30 | 35 | 24 |
| C | 44 | 43 | 41 | 36 | 34 | 35 | 40 | 29 | 30 | 36 |

The user specified the following parameters:

Input Parameters:

CPI(s): C

BPI(s): B

CPI Time Period: CPIsd=1-Mar to CPIed=15-Jul

Number of Iterations: N=1

Iteration Step Length in days: L=30

Number of Sampling Points: n=10

### Step 2

Define Correlationships by iterating through all possible BPI Time Periods as specified by the input Number of Iterations and Iteration Step Length. Given a group of CPIs and BPIs the algorithm iterates through all possible CPI-BPI pairs. For each CPI-BPI pair a Correlationship is defined as follows. We have:

i=−1, 0, 1; BPIsdᵢ=CPIsd+i·L;

BPIedᵢ=BPIsdᵢ+(CPIed−CPIsd); Lagᵢ=CPIsd−BPIsdᵢ

Therefore, see the summary in Table 3.

TABLE 3

| Correlationship −1: | Correlationship 0: | Correlationship 1: |
|---|---|---|
| CPI quantity: C | CPI quantity: C | CPI quantity: C |
| BPI quantity: B | BPI quantity: B | BPI quantity: B |
| CPI Time Period: | CPI Time Period: | CPI Time Period: |
| CPIsd = 1-Mar to | CPIsd = 1-Mar to | CPIsd = 1-Mar to |
| CPIed = 15-Jul | CPIed = 15-Jul | CPIed = 15-Jul |
| BPI Time Period: | BPI Time Period: | BPI Time Period: |
| BPIsd−₁ = 30-Jan | BPIsd₀ = 1-Mar to | BPIsd₁ = 30-Mar to |
| to BPIed−₁ = 15-Jun | BPIed₀ = 15-Jul | BPIed₁ = 14-Aug |
| Number of Sampling | Number of Sampling | Number of Sampling |
| Points: n = 10 | Points: n = 10 | Points: n = 10 |
| Lag−₁ = 30 days_{—} | Lag₀ = 0 days | Lag₁ = −30 days |

### Step 3 for Correlationship −1

Resample both CPI and BPI quantities using the specified Number of Sampling Points for the given Time Periods to convert both quantities to the same format:

C Time Period: CPIsd = 1-Mar to CPIed = 15-Jul
B Time Period: BPIsd-₁ = 30-Jan to BPIed-₁ = 15-Jun
Number of Sampling Points: n = 10

$\begin{matrix}TimeStepLength = \frac{CPIed - CPIsd}{n - 1} = 15 days \\ j = 0 , … , 9\end{matrix}$

TimeCⱼ = CPIsd + j · TimeStepLength and TimeBⱼ = BPIsd + j · TimeStepLength

| | | | | | | | | | |
|---|---|---|---|---|---|---|---|---|---|
| TimeC₀ | TimeC₁ | TimeC₂ | TimeC₃ | TimeC₄ | TimeC₅ | TimeC₆ | TimeC₇ | TimeC₈ | TimeC₉ |
| 1-Mar | 16-Mar | 1-Apr | 16-Apr | 1-May | 16-May | 31-May | 15-Jun | 30-Jun | 15-Jul |
| TimeB₀ | TimeB₁ | TimeB₂ | TimeB₃ | TimeB₄ | TimeB₅ | TimeB₆ | TimeB₇ | TimeB₈ | TimeB₉ |
| 30-Jan | 14-Feb | 1-Mar | 16-Mar | 1-Apr | 16-Apr | 1-May | 16-May | 31-May | 15-Jun |

Now calculate the values of the quantities at those time instants.

cⱼ=Ave([TimeCⱼ−st_{C}, TimeCⱼ+st_{C}]); bⱼ=Ave([TimeBⱼ−st_{B}, TimeBⱼ+st_{B}])

Where Ave([TimeCj−st_{C}, TimeCⱼ+st_{C}]) is the average of values for the C quantity for the time period from TimeCj−st_{C} to TimeCj+st_{C} and st_{C}=st_{B}=14 days

| c₀ | c₁ | C₂ | c₃ | C₄ | c₅ | c₆ | c₇ | c₈ | c₉ |
|---|---|---|---|---|---|---|---|---|---|
| 1-Mar | 16-Mar | 1-Apr | 16-Apr | 1-May | 16-May | 31-May | 15-Jun | 30-Jun | 15-Jul |
| 38 | 37 | 33 | 29 | 35 | 45 | — | 59 | 62 | 48 |
| b₀ | b₁ | b₂ | b₃ | b₄ | b₅ | b₆ | b₇ | b₈ | b₉ |
| 30-Jan | 14-Feb | 1-Mar | 16-Mar | 1-Apr | 16-Apr | 1-May | 16-May | 31-May | 15-Jun |
| 45 | 61 | — | 34 | 33 | 32 | 28 | 24 | 30 | 40 |

For quantity C the above procedure was unable to calculate the value for the time instant of 31-May. The same happened for quantity B for time instant 1-May.

### Special Case of Undefined Values: Method 1

If either of the quantities is not defined for a time step then both quantities will have this step's value as the respective mean of defined step values of the respective quantity. The average of all defined values (9 of them) of quantity C is 38.6. The average of all defined values (9 of them) of quantity B is 33.7. Therefore, the resampled values become:

| c₀ | c₁ | c₂ | c₃ | C₄ | c₅ | c₆ | c₇ | c₈ | c₉ |
|---|---|---|---|---|---|---|---|---|---|
| 1-Mar | 16-Mar | 1-Apr | 16-Apr | 1-May | 16-May | 31-May | 15-Jun | 30-Jun | 15-Jul |
| 38 | 37 | 38.6 | 29 | 35 | 45 | 38.6 | 59 | 62 | 48 |
| b₀ | b₁ | b₂ | b₃ | b₄ | b₅ | b₆ | b₇ | b₈ | b₉ |
| 30-Jan | 14-Feb | 1-Mar | 16-Mar | 1-Apr | 16-Apr | 1-May | 16-May | 31-May | 15-Jun |
| 45 | 61 | 33.7 | 34 | 33 | 32 | 33.7 | 24 | 30 | 40 |

Special Case of Undefined Values: Method 2

The missing value for the time step is computed to be the linear interpolation of the two neighboring values.

$$For Time {C}_{6} = 31 May$$

$$TTD = Time \vec{{C}_{j + 1}} - Time \overleftarrow{{C}_{j - 1}} = 31 May - 15 May = 31 days$$

$$Δ T = Time {C}_{j} - Time \overleftarrow{{C}_{j - 1}} = 31 May - 15 May = 16 days$$

$${R}_{C} = \frac{Δ T}{TTD} = 0.52$$

$${c}_{6} = \overleftarrow{{c}_{5}} + {R}_{C} \cdot ( \vec{{c}_{7}} - \overleftarrow{{c}_{5}} ) = 52.3$$

Where
Time Cⱼ₊₁—time stamp of the first value for quantity C in the database after TimeCⱼ
Time Cⱼ₋₁—time stamp of the last value for quantity C in the database before Time Cⱼ
Cⱼ₊₁—first value for quantity C in the database after TimeCⱼ
Cⱼ₋₁—last value for quantity C in the database before TimeCⱼ

Similarly,

c₂= [symbol] +R_{B}·(\vec{c}₃− [symbol] )=48.6
In this example we will use the results of the first method of undefined values.
Calculation of the Certainty value
Only if both quantities return a value for a particular time step we consider this step to be
successfully contributing to the Correlation Coefficient. We count the number of steps successfully contributing to the Correlation Coefficient; k=8.

$$Certainty = \frac{k}{n} \cdot 100 \% = 80 \%$$

### Step 4 for Correlationship −1

Calculate the Correlation Coefficient for this Correlationship.

Given

| c₀ | c₁ | c₂ | c₃ | c₄ | c₅ | c₆ | c₇ | c₈ | c₉ |
|---|---|---|---|---|---|---|---|---|---|
| 38 | 37 | 38.6 | 29 | 35 | 45 | 38.6 | 59 | 62 | 48 |
| b₀ | b₁ | b₂ | b₃ | b₄ | b₅ | b₆ | b₇ | b₈ | b₉ |
| 45 | 61 | 33.7 | 34 | 33 | 32 | 33.7 | 24 | 30 | 40 |

We compute the following

$${μ}_{B} = \frac{1}{n} {\sum }_{i = 1}^{n} {b}_{i} = 36.6$$

$${μ}_{C} = \frac{1}{n} {\sum }_{i = 1}^{n} {C}_{i} = 43$$

Simplifying the formula we get

$$\begin{matrix} \\ {ρ}_{C , B} = \frac{{\sum }_{j = 1}^{n} ( {μ}_{B} - {b}_{i} ) ( {μ}_{C} - {c}_{i} )}{\sqrt{{\sum }_{i = 1}^{n} {( {μ}_{B} - {b}_{i} )}^{2}} \sqrt{{\sum }_{i = 1}^{n} {( {μ}_{C} - {c}_{i} )}^{2}}} = - 0.43 \\ \end{matrix}$$

Refer to Table 4.

TABLE 4

| Correlationship −1: | Correlationship 0: | Correlationship 1: |
|---|---|---|
| CPI quantity: C | CPI quantity: C | CPI quantity: C |
| BPI quantity: B | BPI quantity: B | BPI quantity: B |
| CPI Time Period: CPIsd = 1-Mar | CPI Time Period: CPIsd = 1-Mar | CPI Time Period: CPIsd = 1- |
| to CPIed = 15-Jul | to CPIed = 15-Jul | Mar |
| BPI Time Period: | BPI Time Period: BPIsd₀ = 1-Mar to | to CPIed = 15-Jul |
| BPIsd−₁ = 30- | BPIed₀ = 15-Jul | BPI Time Period: BPIsd₁ = 30- |
| Jan to BPIed − 1 = 15-Jun | Number of Sampling Points: | Mar to BPIed1 = 14-Aug |
| Number of Sampling Points: | n = 10 | Number of Sampling Points: |
| n = 10 | Lag₀ = 0 days | n = 10 |
| Lag₋₁ = 30 days | Correlation Coefficient = 0.64 | Lag₁ = −30 days |
| Correlation Coefficient = −0.43 | Certainty = 80% | Correlation Coefficient = 0.82 |
| Certainty = 80% | | Certainty = 80% |

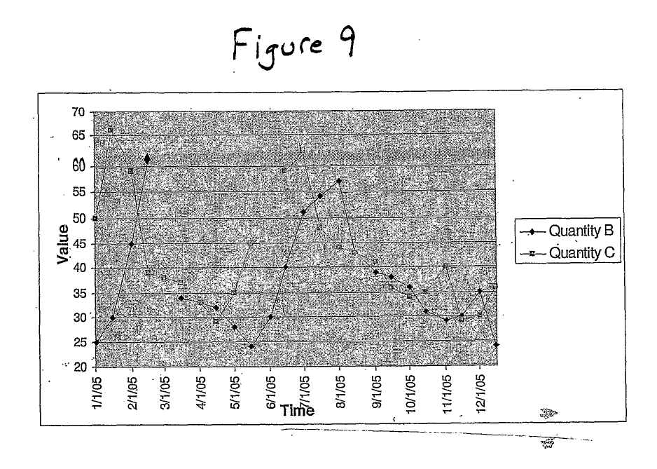

Referring to FIG. 9, the two quantities are strongly correlated for Correlationships that have a Lag of about 30 days where quantity C is “lagging” behind quantity B. This would result in a relatively strong positive correlation, which is exactly what we see for Correlationship 1 above.

In one embodiment, the SMF 100 is a desktop computer application that is either downloaded or provided on a compact disk. In another embodiment, the SMF 100 is provided in booklet form for reproduction on a copy machine. In still another embodiment, the SMF 100 is offered as an Internet hosted application. In another embodiment, a company licenses the SMF 100 to a customer, who in turn establishes access for users on a local network.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustrations other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

What is claimed is:

1. A framework for measuring a perceived value of a service comprising:
a service modeling section for parsing the service into constituent modeled factors to create a service matrix having a plurality of nodes, each node being representative of a category of service performance;
a data measurement section for inputting values for the modeled factors;
a data analysis section for calculating a customer satisfaction figure of merit; and
a system feedback section for providing output based upon the customer satisfaction figure of merit.

2. A framework as recited in claim 1, wherein the customer satisfaction figure of merit is calculated based upon a weighted average of the categories.

3. A method for measuring satisfaction within a service environment comprising the steps of:
(a) modeling contractual customer service relationships using a hierarchical composition model with discrete abstract elements;
(b) creating and distributing customer perception surveys having questions, wherein the questions are dynamically generated from a computer database based on events within the service environment and element weightings within a hierarchical composition model;
(c) collecting and analyzing the customer perception surveys;
(d) calculating aggregate measures of customer perception that have statistical reliability;
(e) correlating the measures of customer perception to create at least one statistical causality between customer perception and business performance; and
(f) adjusting the element weights using calculated customer perception measures and statistical correlation measures to refine reliability of future analysis and calculation results.

4. A server for facilitating analysis of service performance, wherein the server comprises:
(a) a memory storing an instruction set and data related to a plurality of service categories, each service category having a plurality of questions associated therewith; and
(b) a processor for running the instruction set, the processor being in communication with the memory and the distributed computing network, wherein the processor is operative to:
(i) model customer groups, service categories and service value;
(ii) analyze a customer performance indicator (CPI) based upon the modeling of step (i);
(iii) analyze a business performance indicator (BPI) based upon the modeling of step (i); and
(iv) correlate a relationship between the CPI and BPI.

5. A method for evaluating service performance comprising the steps of:
modeling customer groups;
breaking service provided to the customer groups into constituent factors that are part of a service matrix;
model service elements within the service matrix;
directly measure importance of the service elements within the customer groups;
create a model service map by using process mapping to model service categories;
measure satisfaction related to the service categories through dynamic evaluations;
analyze a customer performance indicator based on the satisfaction;
analyze a business performance indicator;
isolate driver relationships based on the customer performance indicator and business performance indicator; and
evaluate a statistical relationship between the customer performance indicator and business performance indicator.

6. A method as recited in claim 6, wherein the customer performance indicator is created by calculating, for a given respondent:
CPIₘₑₐₙₛ=Avg(Qscores).

7. A method as recited in claim 6, wherein the customer performance indicator is created by calculating, from the values of other customer performance indicators:
CPI_{mod}=F({CPI₁,CPI₂, . . . ,CPIₘ})
where F is a function as follows:
CPI_{mod}=IMP₁*CPI₁+IMP₂*CPI₂+ . . . +IMPₙ*CPIₙ
where IMPS are importance customer performance indicators.
